(19) United States
(12) Patent Application Publication
(10) Pub. No.: US 2009/0250562 A1
(43) Pub. Date: Oct. 8, 2009

(54) Clothing Display and Kit

(76) Inventor: Steven R. Jupitz, Baltimore, MD (US)

Correspondence Address: The Marbury Law Group, PLLC, 11800 SUNRISE VALLEY DRIVE, SUITE 1000, RESTON, VA, 20191, US

(21) Appl. No.: 12/404,512

(22) Filed: Mar. 16, 2009

Related U.S. Application Data
(60) Provisional application No. 61/042,343, filed on Apr. 4, 2008.

(51) Int. Cl. F16M 11/02; F16M 11/04

(52) U.S. Cl. 248/121; 248/176.1; 248/176.3

(57) ABSTRACT

A display for an article of clothing, such as sports memorabilia jerseys, has a frame and a three-dimensional body including a torso over which the clothing is placed. The top portion of the torso has right and left shoulders and a plunging V-shape in the middle. The torso preferably includes structure to accommodate excess fabric and is supported from a lower portion by a support member or hanger arm that passes through an opening in a rear panel of the frame and is secured to the frame to support the clothing in a non-visible manner. The frame can include a glass front and a matte to display and protect the clothing.

### RELATED APPLICATIONS

This application claims the benefit of U.S. Provisional Application Ser. No. 61/042,343, filed Apr. 4, 2008, which is hereby incorporated by reference for all purposes.

### BACKGROUND

Embodiments referred to herein relate to the display of articles of clothing, such as sports memorabilia jerseys, generally in a manner suitable for display on a wall.

Prior art sports memorabilia displays have primarily either involved framing of a flattened jersey or the hanging of the jersey from a coat-hanger. While flattening a jersey might be an expedient way to frame it, the resulting display may not be particularly attractive. A jersey designed to be worn on a three-dimensional athlete can also appear abnormally wide when flattened.

Similarly, the use of a coat-hanger can be expedient. However, the hanger will be visible to viewers and will not always project the desired “reverence” for the article. Additionally, with the use of a hanger, there is no way to support the lower portion of the jersey or address excess material that is usually “tucked in” when worn by the athlete.

### BRIEF SUMMARY

Various embodiments disclosed herein employ a three-dimensional form that, in its most basic embodiments, comprises the three-dimensional body with a torso over which the article of clothing is placed. The top portion of the torso or torso member (hereinafter referred to as “torso”) has right and left shoulders and a plunging V-shape in the middle. The shoulders can be minimal (i.e., just enough to support a basketball jersey) or larger for supporting other types of jerseys or clothing.

The three-dimensional body, over which the clothing is placed, can be supported in a non-visible manner within a frame for display. The torso can include structure to accommodate excess fabric and is supported from a lower portion by a support member or hanger arm that passes through an opening in a rear panel of the frame and is secured to the frame to support the clothing without being visible from the front of the display. The frame can include a glass front and a matte to display and protect the clothing.

In one embodiment, the base or lower portion of the torso has a front surface that extends lower than the rear surface so as to form a hollow area between the front and the rear surfaces. The hollow area allows the lower part of the jersey or other article of clothing to be pulled around the front and rear of the torso and tucked into the hollow space. A lower end of a support member is then inserted to secure the jersey or other article of clothing and support the torso. The lower end of the support and the hollow portion are dimensioned to allow frictional engagement while allowing for the thickness of the fabric.

In another embodiment, the torso has fabric clipping surfaces extending from the rear surface of the torso that allow excess portions of the jersey or other article of clothing to be pulled around the front and rear of the torso and clipped or otherwise secured to the fabric clipping surfaces.

In certain embodiments, an upper portion of the support member passes through an opening in the rear of the frame. The opening is preferably positioned so as to be obscured from view by the displayed clothing. The support member can then be secured to the frame in a non-visible manner. The rear opening preferably is centered so that the displayed article of clothing will be centered. The frame can use a traditional support wire or can include a hanger member on the support member, which will then support both the article of clothing (via the lower end supporting the form with the article of clothing) and the frame (via being secured to the frame). The frame can include a glass front and a matte to display and protect the article of clothing.

To address different types of clothing articles, the three-dimensional body can include three-dimensional sleeve members attached by support members. The three-dimensional body can also include shoulder angles or pads for placement on top of the torso shoulders to alter the angle of the shoulders, thus simulating athletes with or without shoulder pads. While football jerseys, hockey jerseys and lacrosse jerseys (which are meant to go over shoulder pads) can use a flat shoulder on the form, other jerseys, such as baseball and soccer jerseys, will look better with a tapered or angle on the shoulder. This can be integral to the form or supplied by the additional shoulder wedges or pads.

Other modifications can include providing the elements in a kit form, forming the three-dimensional body elements with blow molding, integrating sleeve members into the three-dimensional body, providing long sleeves, providing body contours on front surface elements, and forming the torso from sectional and/or adjustable elements.

### BRIEF DESCRIPTION OF THE DRAWINGS

FIG. 1 illustrates an embodiment of a three-dimensional support body for an article of clothing, in this case a sports memorabilia jersey.

FIG. 2 illustrates an embodiment of a torso member.

FIG. 3 illustrates an embodiment of a side view of a lower portion of a torso member.

FIGS. 4A and 4B illustrate alternate embodiments of shoulders and shoulder wedges.

FIGS. 5A and 5B illustrate alternate embodiments of front surface body contours.

FIG. 6 illustrates an embodiment of a bifurcated torso member.

FIGS. 7A and 7B illustrate details of an embodiment of a lower support member.

FIG. 8 illustrates a rear view of an embodiment.

FIG. 9 illustrates a side cross section of an embodiment of a memorabilia display for an article of clothing.

FIG. 10 illustrates an embodiment of components of a three-dimensional support body.

FIG. 11 illustrates a front view of a partial assembly of an embodiment.

FIG. 12 illustrates a rear oblique view of the partial assembly of FIG. 11.

FIG. 13 illustrates a front view of a fully-optioned assembly of an embodiment.

FIG. 14 illustrates a top view of the embodiment of FIG. 13.

FIG. 15 illustrates a rear oblique view of the embodiment of FIG. 13.

FIG. 16 illustrates a front perspective view of an embodiment with shoulder and sleeve components removed on one side to show details.

FIG. 17 illustrates a side view of the embodiment of FIG. 13.

FIG. 18 illustrates a side view of an embodiment in a box frame.

### DETAILED DESCRIPTION

Various embodiments comprise a display for an article of clothing, such as sports memorabilia jerseys, which has a frame and a three-dimensional body including a torso over which the clothing is placed. The top portion of the torso has right and left shoulders and a plunging V-shape in the middle. The torso includes structure to accommodate excess fabric and is supported from a lower portion by a support member or hanger arm that passes through an opening in a rear panel of the frame and is secured to the frame to support the clothing in a non-visible manner. The frame can include a glass front and a matte to display and protect the clothing.

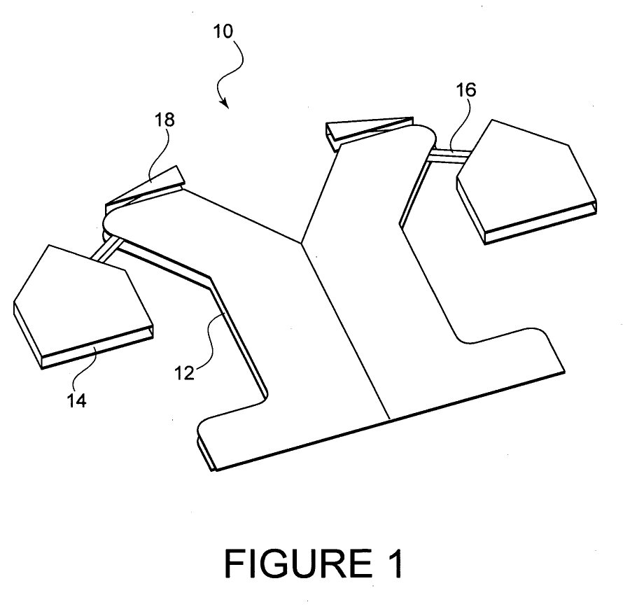

One embodiment of a three-dimensional body is illustrated in FIG. 1. The three-dimensional body 10 is formed with a torso 12, optional sleeve members 14 secured with elongated attachment members 16, and optional shoulder wedges 18 that can be used to vary the top angle (i.e., drape angle) of the shoulders. These elements can be formed of any suitable material, including but not limited to plexiglass or other plastic sheets, blow-molded plastic, injection-molded plastic, rigid plastic foam, wood, clay, and sheet metal, although these are not meant as limitations. For fabrics that are partially see-through, a dark-colored material is preferred so as to be less visible.

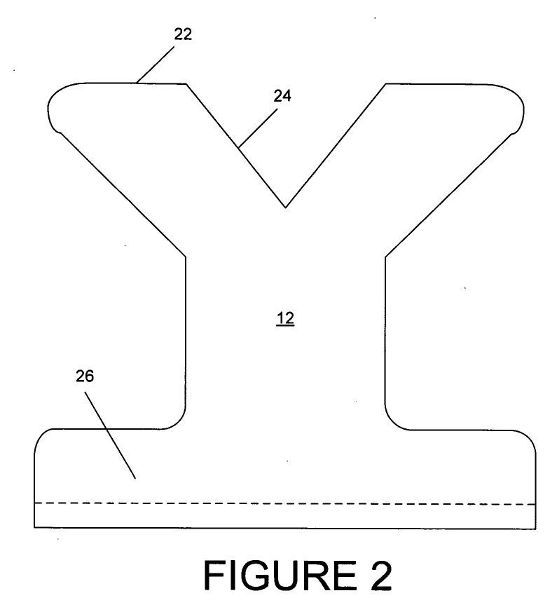

An embodiment of torso 12 is illustrated in FIG. 2, which is not necessarily to scale. Torso 12 is dimensioned for supporting an article of clothing, such as a sports memorabilia jersey, and includes, at an upper end thereof, right and left shoulders 22 with a plunging V-shape 24 in the middle. In use, the shoulders 22 support an upper inside portion of the article of clothing (hereinafter referred to as a “jersey,” although not limited thereto) and the plunging V-shape 24 prevents the torso 12 from being seen through a neck opening of the jersey. In the illustrated embodiment, the torso 12 narrows between the shoulders 22 and the lower portion 26. While not strictly needed, this narrowing provides room for placement of three-dimensional sleeve members 14 and allows the sides of a jersey to taper somewhat.

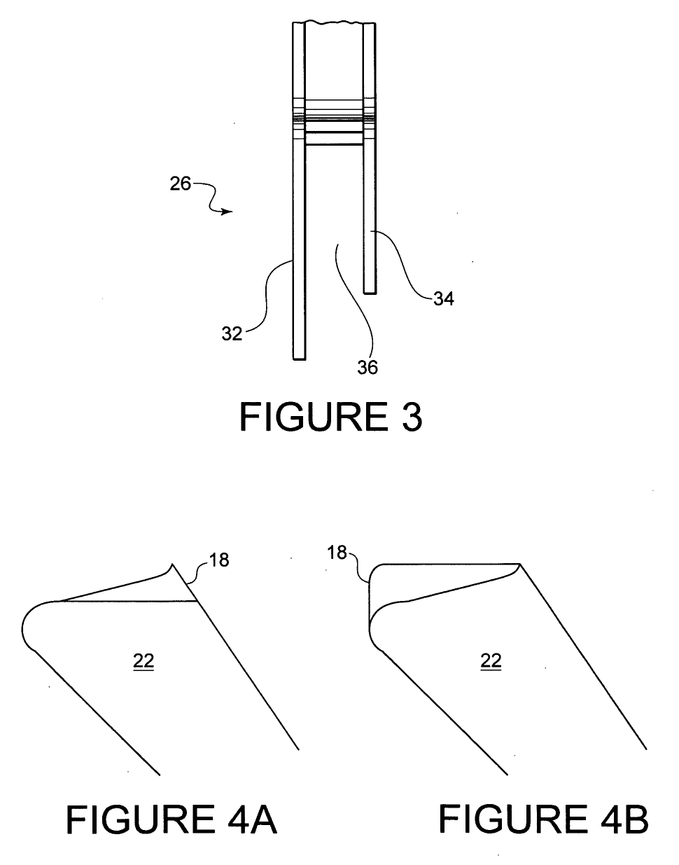

As illustrated in FIGS. 2 and 3, the torso 12 has a front surface 32 and a rear surface or edge 34 that are spaced from one another. This spacing is sufficient to impart a three-dimensional look to a display, but is preferably small enough to allow use of readily available frames. At a lower end 26 of torso 12, the front surface 32 extends lower than the rear surface 34 and a hollow area 36 is formed between the surfaces 32 and 34. The hollow area 36 allows the lower portions of a jersey to be wrapped around the lower portion of the torso 12 and tucked into the space provided by the hollow area to provide for a neat appearance. When this hollow area 36 is engaged by a support member, the lower-extending portion of front surface 32 acts to hide the support member, further improving the appearance of the display.

While the shoulders 22 in FIG. 2 are illustrated as flat so as to use a shoulder wedge 18 to form an angle, as illustrated in FIG. 4A, it is also possible to form the shoulder 22 at an angle and use shoulder wedges 18 to make them flat, as illustrated in FIG. 4B. As previously mentioned, football jerseys, hockey jerseys and lacrosse jerseys (which are meant to go over shoulder pads) can use a flat shoulder on the form, and other jerseys, such as baseball and soccer jerseys, will look better with an angle on the shoulder.

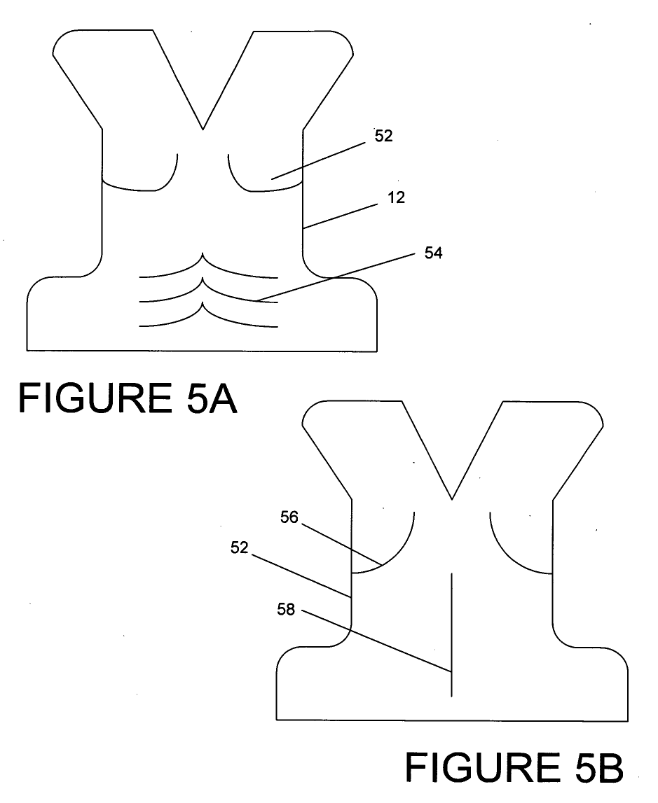

In some embodiments, it may be desirable to provide contours simulating a human body to the front surface of the torso 12. Examples of when this might be desirable include use with tight-fitting or clingy articles of clothing or with jerseys that are “cut-off” to expose the abdomen or lower back. FIG. 5A illustrates body contours simulating the front surface of a human torso with a human chest 52 and abdomen 54. While a male torso is simulated, a female torso can be simulated in a similar fashion. FIG. 5B illustrates body contours simulating the back surface of a human torso with a shoulder blades 56 and lower back/spine 58.

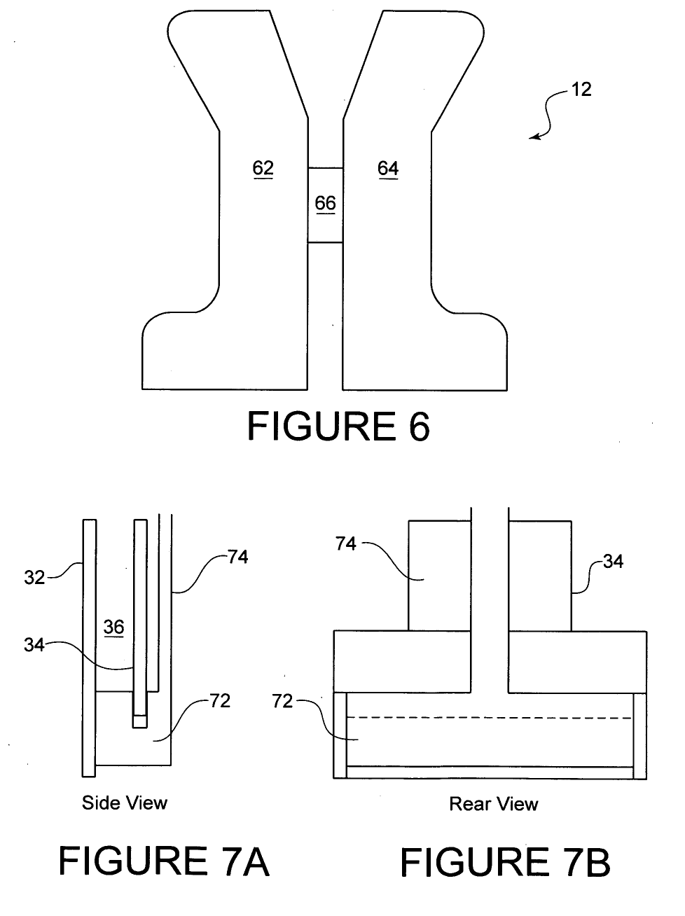

FIG. 6 illustrates an embodiment wherein torso 12 is bifurcated into portions 62 and 64 that are joined together for use, such as by element 66. Bifurcation of the torso 12 might be desirable to reduce the size of the torso 12, such as for shipping manufacturing, and/or for allowing the torso 12 to be adjusted for width (as shown) or for height (if bifurcated vertically).

FIGS. 7A and 7B illustrate details of how an embodiment supports the torso of the three-dimensional body. A lower portion 72 of a support member is dimensioned to engage, preferably in a friction fit, the hollow area 36 formed between front surface 32 and rear surface 34 of the torso. An offset upper portion 74 of the support member extends vertically and is secured so as to support the three-dimensional body over which the jersey is displayed.

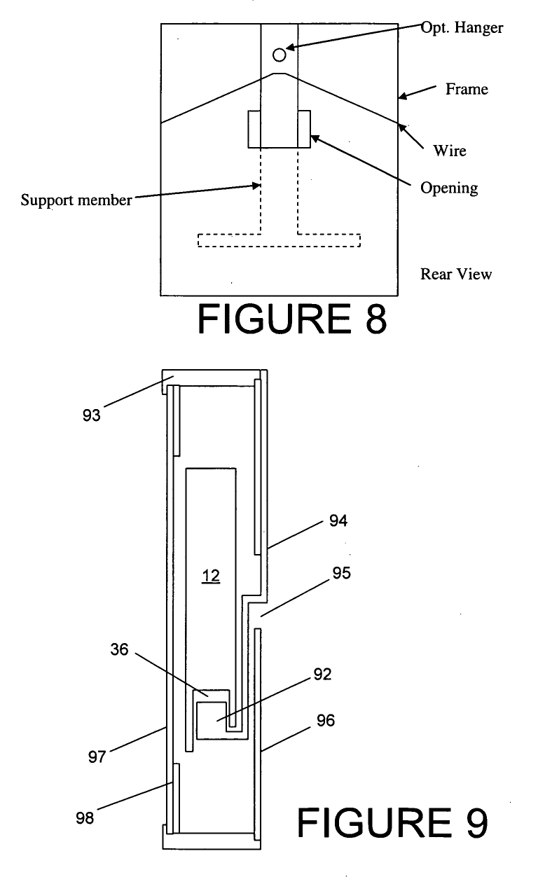

As illustrated in FIG. 8, the upper portion of the support member 84 can extend through an opening 85 in the back of a frame 83 and be secured to the frame 83. In such a manner, the three-dimensional body displaying the jersey can be supported in a non-visible manner. The frame 83 can include an ordinary hanger, such as a wire 86, or the upper portion of the support member 84 can include a means 87 for hanging the frame. While illustrated as a single horizontal member, the lower portion of the support member can take any other suitable form, such as two smaller (i.e., left and right) members, without departing from the scope of the invention. Likewise, while the upper portion is illustrated as a flat strip, other forms can be used.

FIG. 9 illustrates a cross-section of an embodiment of a memorabilia display. Torso 12 (with or without sleeves and/or shoulder angles) is supported by a support member that engages the hollow area 36 of torso 12 at a lower end 92. The support member extends through an opening 95 in a back panel 96 and the upper portion 94 is secured to frame 93. A transparent (i.e., glass) panel 97 is included at the front of the frame 93 and a matte 98 can be used to artfully display the memorabilia. In such a manner, a jersey or the like can be supported and displayed three-dimensionally within the frame 93 without any visible means of support as viewed from the front of the display. While the upper portion 94 of the support member is disclosed as having an offset adjacent the opening 95, such an offset is optional if a suitably thin and flexible material is used for the upper portion 94 of the support member. While disclosed as mounted in a frame, it is also possible to secure the upper portion 94 of the support member directly to a wall and display the jersey in an open, unprotected manner (albeit without any visible means of support).

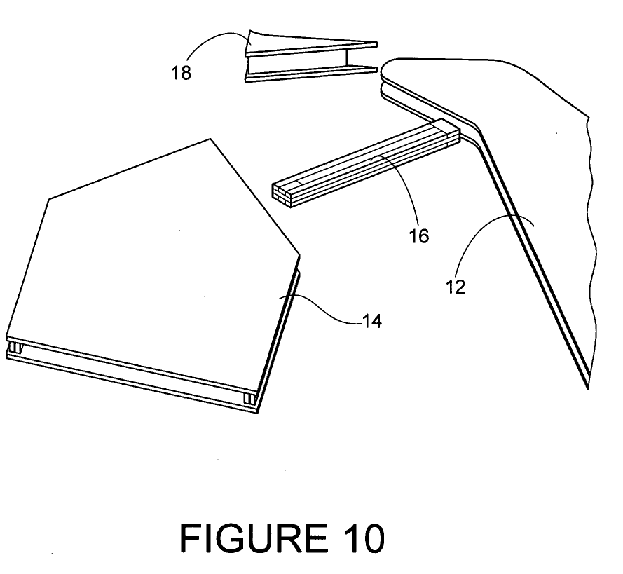

FIG. 10 illustrates another view of the optional elements that can be included with the torso 12 to form a three-dimensional body. When using spaced plexiglass panels for the torso 12 and sleeve members 14, the sleeve support members 16 can be elongated members that are sized to slide between the panels and be fastened (by adhesive or fastener) to position and support the sleeve members 14. Similarly, the shoulder angles 18 are sized to be attached (such as by adhesive) to the spaced panels at the shoulders of the torso 12.

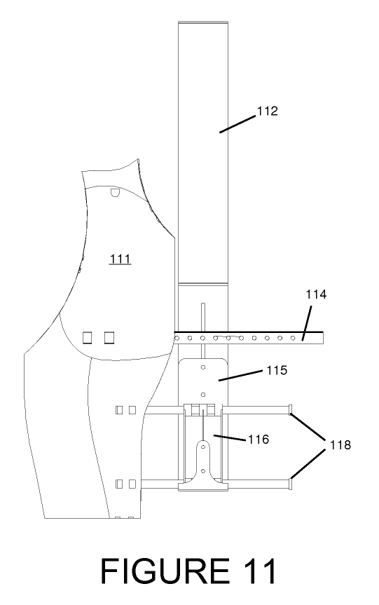

FIGS. 11-18 illustrate various views of another embodiment. FIG. 11 illustrates a front view of a partial assembly of a split-torso embodiment that employs right and left torso elements 111 for the clothing display form. The torso elements 111 can be adjusted in a width direction by telescoping upper bar 114. The illustrated portion of bar 114 is the outer bar and optionally includes a plurality of spaced holes or detents that a spring-loaded ball or lug on an inner bar can engage to adjust the width spacing of the torso elements 111 and secure the bar 114 at the desired width. Although disclosed in this embodiment as telescoping cylindrical tubes, the telescoping upper bar 114 is not meant to be limited to any particular form or cross-section and can take many other forms, including, but not limited to, square, rectangular, triangular, oval, and D-shaped tubes and/or channels. Further, the telescoping upper bar 114 does not need to be concentric, can comprise a plurality of support elements joined by guides that allow extension of the elements in the width direction, and can be made of any suitable material, such as aluminum, wood, or plastic.

The torso elements 111 can be formed of any suitable material, including, but not limited to, plastic, wood, structural foam, metal mesh, paper mache, molded fiber, shaped paperboard, and the like. The front of the torso elements 111 preferably include pectoral and abdominal contours that simulate the torso of a human, but the relief aspect (depth) of the contouring on the elements 111 should be less than the actual contours of a human torso, with the total depth of the torso elements 111 preferably limited to approximately 1.5 to 3 inches (˜4 to 8 centimeters) so as to fit inside a typical box frame.

A pair of lower center bars 118 is secured in a spaced relationship with a center stabilizer 116. Again, although disclosed as cylindrical tubes or bars, the lower center bars 118 are not meant to be limited to any particular form or cross-section and can take many other forms, including, but not limited to, square, rectangular, triangular, oval, I, C, L, T and D-shaped beams, tubes and/or channels. The lower center bars 118 can be made of any suitable material, such as aluminum, wood, or plastic. The bars 118 engage corresponding slots on the lower portion of each torso 111 to support the torso (and displayed clothing, not shown) and preferably include stops or caps at the end of bars 118 to prevent the torso 111 from unintentionally sliding off the lower support bars 118.

The central stabilizer 116 is preferably made of suitably rigid material such as wood, metal, plastic, expanded polystyrene, and the like, although this is not meant as a limitation. The stabilizer 116 is supported by a central adjuster 115. The central adjuster 115 is preferably formed of aluminum or other metal sheet and has a back plate with mounting holes for attachment (with appropriate fasteners) to hanger arm 112. The bottom of the back plate is curved to form a cradle for the central stabilizer 116 and a front plate or portion of the central adjuster 115 includes mounting holes for attachment (with appropriate fasteners) to the central stabilizer 116. In this manner, the torso elements 111 (and associated clothing) are vertically positioned and attached to hanger arm 112 that supports the form and clothing being displayed in the box frame.

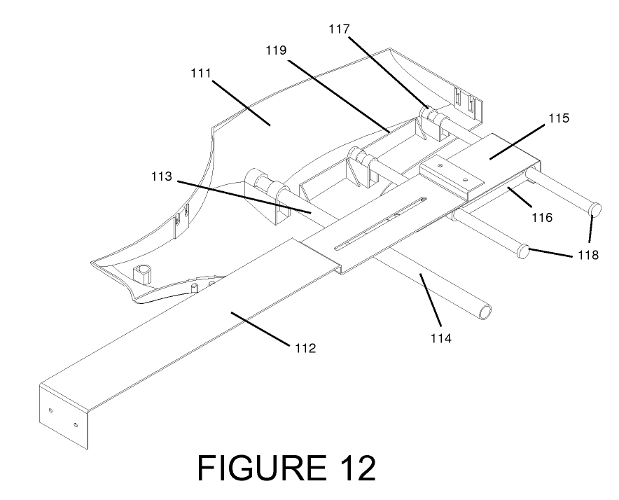

FIG. 12 illustrates a rear oblique view of the partial assembly of FIG. 11, with inner bar 113 of the upper telescoping bar 114 and lower center bars 118 engaging appropriately-sized attachment slots 117 on the back side of torso element 111. The back side of torso element 111 can further include fabric clipping surfaces 119 which can be used to gather and secure excess fabric of the displayed clothing with clips. In this manner, excess fabric can be hidden and secured behind the torso element 111. While vertical fabric clipping surfaces 119 are illustrated, horizontal and diagonal surfaces can also be used, as appropriate. The lower portion of hanger arm 112 preferably includes a structure, such as the illustrated slot, for adjustable attachment to the back plate of central adjuster 115 using appropriate fasteners. The fasteners can be moved vertically along the slot to adjust the vertical position of the torso elements 111.

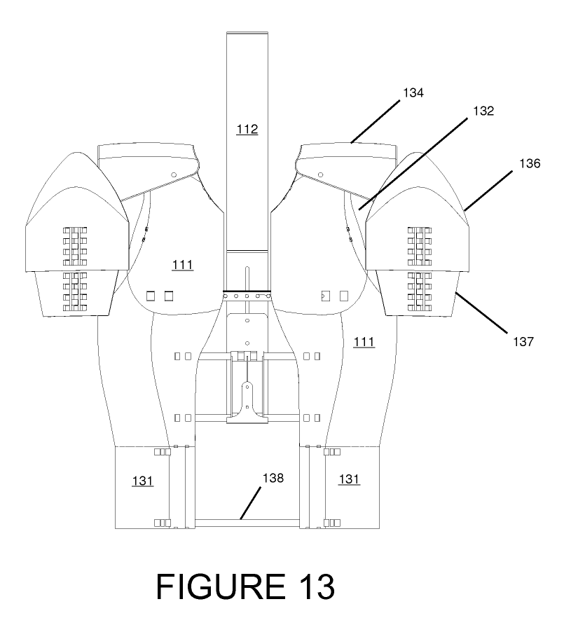

For display of tank-top style clothing such as basketball and track & field jerseys, a mirror-image torso element 111 is attached to the other side of the upper telescoping bar 114 and the lower center bars 118 in order to display the clothing over the 3D form, as discussed earlier with respect to FIG. 9. For other types of clothing that is longer or has sleeves or is meant to be worn over shoulder pads, additional optional elements can be added to the torso elements 111. FIG. 13 illustrates a front view of a fully-optioned assembly of an embodiment for an item of clothing that has sleeves and is designed for use with shoulder pads, such as a hockey or football jersey. Since larger athletes may also be taller, lower extensions 131 can be attached, such as with fasteners or adhesive, to the bottom of torso elements 111 and secured in a spaced relationship with bottom bar 138. At the upper end of the torso elements 111, torso side arms 132 can be attached, such as with fasteners or adhesive, to form shoulders for the 3D form. Lugs on the back of shoulder plates 134 can be attached to holes in the top front of the torso elements 111. If the lugs and holes are round, the shoulder plates 134 can be rotated and adhesively secured at the desired angle. If the lugs and holes are not round, the shoulder plates 134 will be secured at a predetermined angle. In a preferred embodiment, the back of shoulder plates 134 are contoured to lay flat against the contour of torso elements 111 and torso arm sides 132. Arm forms 136 and arm ends 137 are attached to torso side arms 132 to provide a form for the sleeves.

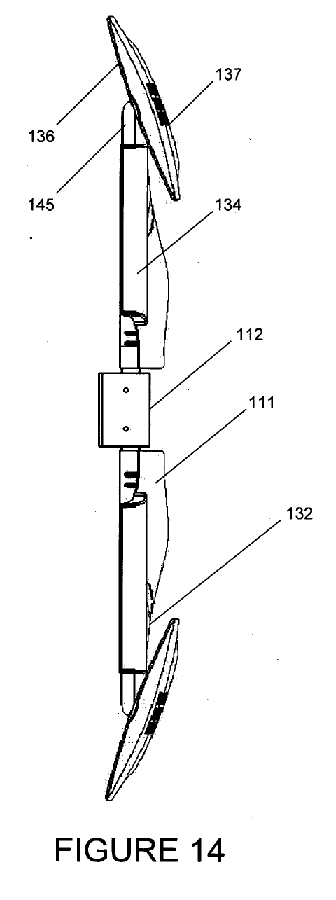

As illustrated in the top view of FIG. 14, arm forms 136 and arm ends 137 can be attached to torso arm sides 132 with a substantially L-shaped arm side bar 145, which, as explained below, allows rotation of the arm forms 136 and arm ends 137 in two dimensions so as to overlap other elements of the clothing form. The 3D characteristics (depth) of the torso elements 111, shoulder plates 134, arm forms 136 and arm ends 137 can be seen in this top view. Additionally, it can be seen that the back of hanger arm 112 is offset behind the display to allow it to pass through a hidden opening in a back panel of the box frame (see FIG. 9). In this embodiment, the top of the hanger arm 112 extends horizontally forward to be secured via mounting holes to the top of the box frame.

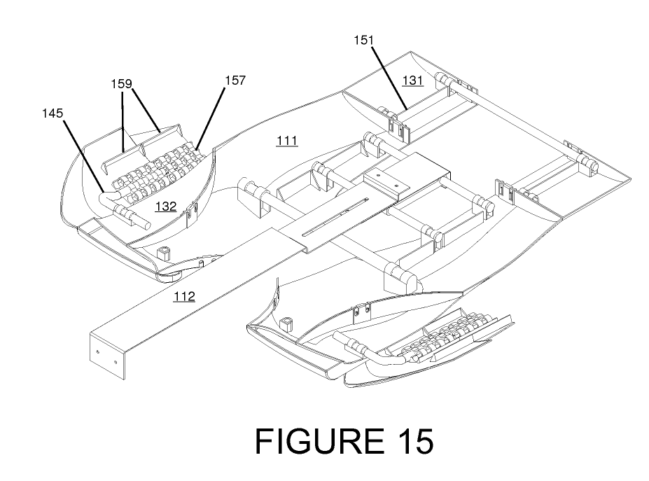

FIG. 15 illustrates a rear oblique view of the embodiment of FIG. 13. Similar to the clipping surfaces 119 on the back of torso elements 111, lower extensions 131 can include clipping surfaces 151, and arm forms 136 and arm ends 137 can include clipping surfaces 159. The substantially L-shaped arm side bar 145 has a first end attached to the torso side arm 132 in a sliding manner so as to be able to adjust the sleeve forms in the width direction, as well as allow them to rotate forward and back a small amount. Additionally, the backside of arm forms 136 and arm ends 137 can include a plurality of slots 157 for engaging the other end of L-shaped arm side bar 145. The slots 157 allow width adjustment by use of different sets of slots 157 and further allow rotational movement of the sleeve forms about the other end of L-shaped arm side bar 145.

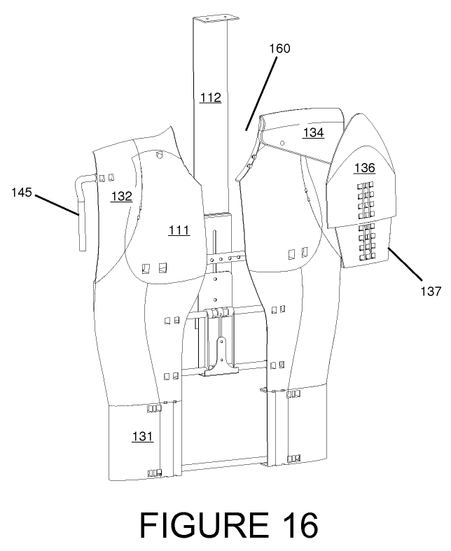

FIG. 16 illustrates a front perspective view of an embodiment with shoulder and sleeve components removed on one side to show details of the substantially L-shaped arm side bar 145 attached to the torso side arm 132, and, on the other side, the shoulder plates 134, arm forms 136 and arm ends 137 in the use position that obscures these details. Since many articles of clothing have scoop or V-necks, it is desirable to have a large, substantially V-shaped open portion 160 between the tops of torso elements 111 so as to not have the clothing form visible when displaying scoop or V-neck tops. Further, it can be seen that the offset section of hanger arm 112 occurs in the central portion below this open portion 160 so that the upper portion of hanger arm 112 will be obscured behind the back panel of the box frame in this open portion 160.

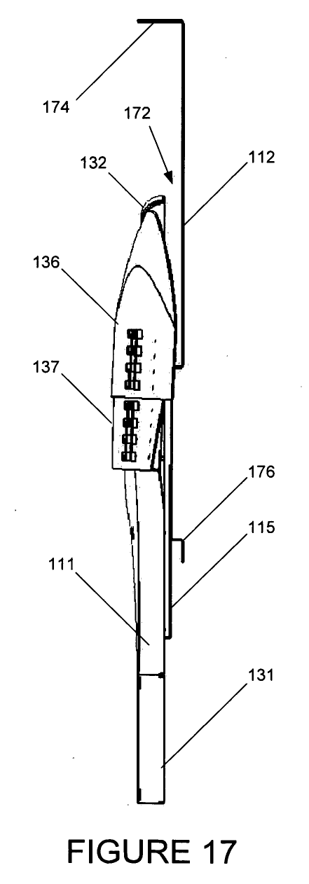

FIG. 17 illustrates a side view of the embodiment of FIG. 13. As with the top view of the embodiment of FIG. 14, the 3D characteristics of shoulder plates 134, arm forms 136, arm ends 137, torso elements 111, and lower extensions 131 are readily apparent. Upper portion of hanger arm 112 is offset by a distance, shown at 172, from the elements located within the display portion of the box frame, including center adjuster 115. In this embodiment, a lowermost portion 176 of hanger arm 112 extends backwards for engaging a positioning slot (not illustrated) in the backing element of the box frame so that the hanger arm 112 is locked into position when the top 174 is secured to the top of the box frame.

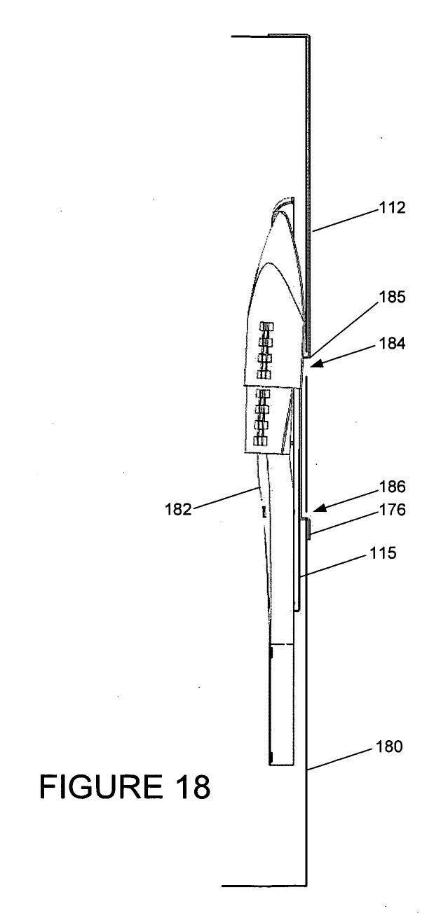

FIG. 18 illustrates a side view of 3D form 182 positioned within a box frame with back panel 180. The 3D form 182 secured to a center adjuster 115 that is adjustably attached to hanger arm 112. An upper portion of hanger arm 112 is offset at 185 so as to pass through an opening 184 in the back panel 180. A lower portion 176 of hanger arm 112 extends backward through a positioning slot 186 to secure the hanger arm 112 and the attached 3D form 182 into position within the box frame.

Elements of the various embodiments can be provided as a kit to consumers and/or framing shops so as to allow jerseys and other similar memorabilia to be displayed.

In one embodiment, a memorabilia display for an article of clothing comprises a display frame and a torso member having a front surface spaced from a rear edge to form a three dimensional clothing form, with the torso member sized and shaped to display the article of clothing. The embodiment further includes a means for attaching a support member at a lower end of the torso member and a rear panel of the display frame has an opening in a location occluded from view when the torso member and article of clothing are placed in the frame. A support member is then connected at it lower end to the means for attaching, and an upper portion of the support member extends through the opening in the rear panel to be secured to the frame.

Preferably, the display frame has a first depth, the front surface and rear edge of the torso member are spaced a distance less than the first depth, and the display frame further comprises a clear front panel. The display frame can further include a matte board adjacent an inner surface of the clear front panel, with the matte board having an opening for display of the article of clothing.

In a variation of this embodiment, the means for attaching comprises a hollow area formed in a lower end of the torso member between the front surface and a rear surface, wherein the front surface extends further than the rear surface. A corresponding plug member at the lower end of the support member is sized to frictionally engage the hollow area at the lower end of the torso member when the article of clothing is wrapped around lower ends of the spaced front and rear surfaces and tucked into the hollow area of the torso member.

In other variations of this embodiment, the torso member further comprises right and left shoulders and a plunging V-shape in the middle sized to support a sports memorabilia jersey. This variation can optionally include right and left sleeve members that each have a front surface spaced from a rear edge. Right and left sleeve attachment members are also provided. Each sleeve attachment member comprises an elongated member with a first end for attachment to a shoulder of the torso member and a second end for attachment to the sleeve.

In another variation of this embodiment, right and left shoulder forms are provided for attachment to an upper surface of the right and left shoulders so as to alter a drape angle of the shoulders.

In another variation of the basic embodiment, the torso member comprises left and right torso elements connected together with a bar that allows adjustable spacing of the left and right torso elements, wherein rear surfaces of the torso elements include surfaces for gathering and securing excess fabric. Optionally, the bar can take the form of a telescoping bar. The means for attaching can optionally comprise a stabilizer supporting a pair of vertically-spaced bars that extend horizontally to engage corresponding support portions of the left and right torso elements and an adjuster member for supporting the stabilizer and attaching in an adjustable manner to the lower end of the support member. Variations can optionally include extensions attached to a lower edge of the left and right torso elements to vertically extend the torso member.

In a variation of this embodiment, the left and right torso elements can have minimal shoulders for supporting a tank-style top and optionally comprise torso side arms attached to the left and right torso elements to form extended shoulders. Embodiments with the torso side arms can further comprise right and left arm forms, where each arm form comprising a front surface spaced from a rear edge, and right and left arm form attachment members, where each arm form attachment member includes a substantially L-shaped member with a first end for attachment to the torso side arms and a second end for attachment to the arm forms. The attachment members on the arm forms can optionally include a plurality of spaced attachment points to allow adjustable arm/sleeve placement and/or arm extensions in the form of left and right arm ends attached to a lower edge of the left and right arm forms. To support clothing that is typically worn over shoulder padding, right and left shoulder pads can optionally be attached to the right and left torso elements.

Further embodiments can include a display hanger structure on the upper portion of the support member. Various embodiments can include contours simulating a human chest or human back on the front surface of the torso member. In a variation of any of the above embodiments, the components are provided unassembled as a kit.

In a typical embodiment, the box frame can be a 32″×40″ shadow box that is 3″ deep. The opening in the rear panel and the dimensions of the support or hanger arm can be chosen so as to allow display of clothing with the shadow box in either a landscape or portrait orientation. Preferably, vertical positioning of the adjuster member on the hanger arm allows sufficient movement to allow vertical centering of the in either orientation. The torso components can typically be made from injection-molded ABS or LDPE plastic to keep costs reasonable, although many other materials could also be used. Additional elements, such as display lighting, photograph backgrounds, photographs, 3-D mattes, signage/logos, non-clothing memorabilia, audio or multimedia players, etc. can be combined with the clothing display, as desired.

A display and kit for displaying articles of clothing has been illustrated. It will be understood by those skilled in the art that other embodiments are possible in other specific forms without departing from the scope as disclosed and that the examples and embodiments described herein are in all respects illustrative and not restrictive. For example, the lower and upper portions of the support member could be made from separate and/or adjustable components for handling jerseys and frames of different sizes. Using the embodiments illustrated herein, various articles of clothing may be displayed such as ceremonial garments, dresses, shirts, shawls and the like. Similar three dimensional forms may be used to display pants as well to the extent that such display is desired. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

What is claimed is:

1. A memorabilia display for an article of clothing comprising:
a display frame;
a torso member having a front surface spaced from a rear edge to form a three dimensional clothing form, the torso member sized and shaped to display the article of clothing;
means for attaching a support member at a lower end of the torso member;
a rear panel of the display frame comprising an opening in a location occluded from view when the torso member and article of clothing are placed in the frame; and
a support member comprising:
a lower end connected to the means for attaching; and
an upper portion that extends through the opening in the rear panel and is secured to the frame.

2. The memorabilia display of claim 1, wherein:
the display frame has a first depth;
the front surface and rear edge of the torso member are spaced a distance less than the first depth; and
the display frame further comprises a clear front panel.

3. The memorabilia display of claim 2, wherein the display frame further comprises:
a matte board adjacent an inner surface of the clear front panel, the matte board having an opening for display of the article of clothing.

4. The memorabilia display of claim 1, wherein the means for attaching comprises:
a hollow area formed in a lower end of the torso member between the front surface and a rear surface wherein the front surface extends further than the rear surface; and
a corresponding plug member at the lower end of the support member that is sized to frictionally engage the hollow area at the lower end of the torso member when the article of clothing is wrapped around lower ends of the spaced front and rear surfaces and tucked into the hollow area of the torso member.

5. The memorabilia display of claim 1, wherein the torso member further comprises right and left shoulders and a plunging V-shape in the middle sized to support a sports memorabilia jersey.

6. The memorabilia display of claim 5, further comprising:
right and left sleeve members, each sleeve member comprising a front surface spaced from a rear edge; and
right and left sleeve attachment members, each sleeve attachment member comprising an elongated member with a first end for attachment to a shoulder of the torso member and a second end for attachment to the sleeve.

7. The memorabilia display of claim 5, further comprising:
right and left shoulder forms for attachment to an upper surface of the right and left shoulders so as to alter a drape angle of the shoulders.

8. The memorabilia display of claim 1, wherein the torso member comprises left and right torso elements connected together with a bar that allows adjustable spacing of the left and right torso elements, wherein rear surfaces of the torso elements include surfaces for gathering and securing excess fabric.

9. The memorabilia display of claim 8, wherein the bar comprises an upper telescoping bar.

10. The memorabilia display of claim 8, wherein the means for attaching comprises:
a stabilizer supporting a pair of vertically-spaced bars that extend horizontally to engage corresponding support portions of the left and right torso elements; and
an adjuster member for supporting the stabilizer and attaching in an adjustable manner to the lower end of the support member.

11. The memorabilia display of claim 8, further comprising extensions attached to a lower edge of the left and right torso elements to vertically extend the torso member.

12. The memorabilia display of claim 8, wherein the left and right torso elements have minimal shoulders for supporting a tank-style top.

13. The memorabilia display of claim 12, further comprising torso side arms attached to the left and right torso elements to form extended shoulders.

14. The memorabilia display of claim 13, further comprising:
right and left arm forms, each arm form comprising a front surface spaced from a rear edge; and
right and left arm form attachment members, each arm form attachment member comprising a substantially L-shaped member with a first end for attachment to the torso side arms and a second end for attachment to the arm forms.

15. The memorabilia display of claim 14, further comprising a plurality of spaced attachment points for the attachment members on the arm forms.

16. The memorabilia display of claim 14, further comprising left and right arm ends attached to a lower edge of the left and right arm forms.

17. The memorabilia display of claim 14, further comprising right and left shoulder pads attached to the right and left torso elements.

18. The memorabilia display of claim 1, wherein the upper portion of the support member further comprises a display hanger.

19. The memorabilia display of claim 1, wherein the front surface of the torso member comprises contours simulating a human chest or human back.

20. The memorabilia display of claim 1, wherein components are provided unassembled as a kit.
